(19) United States
(12) Patent Application Publication
(10) Pub. No.: US 2026/0000062 A1
(43) Pub. Date: Jan. 1, 2026

(54) GAS-GENERATING ASSEMBLY AND MOSQUITO ERADICATION DEVICE

(71) Applicant: Logicarer Biotechnology (Shenzhen) Co., Ltd., Shenzhen (CN)

(72) Inventor: Zhen XIE, Shenzhen (CN)

(73) Assignee: Logicarer Biotechnology (Shenzhen) Co., Ltd., Shenzhen (CN)

(21) Appl. No.: 18/807,079

(22) Filed: Aug. 16, 2024

(30) Foreign Application Priority Data
Jun. 26, 2024 (CN) 202410838667.2

(51) Int. Cl. A01M 1/02; A01M 1/08

(52) U.S. Cl. CPC A01M 1/023; A01M 1/08; A01M 2200/012

(57) ABSTRACT

Disclosed are a gas-generating assembly and a mosquito eradication device. The gas-generating assembly includes a water-collecting structure, a reaction structure provided under the water-collecting structure, and a wind structure. A bottom of the water-collecting structure is formed with an opening, and a surface of the water-collecting is provided with a hydrophilic layer to absorb water vapors in the air. The reaction structure is formed with an accommodation room to place a reactant, and the opening is correspondingly provided above the accommodation room. The wind structure is provided under the water-collecting structure and configured to generate a wind vortex to facilitate airs around the water-collecting structure contacting the hydrophilic layer.

### CROSS-REFERENCE TO RELATED APPLICATIONS

The present application claims priority to Chinese Patent Application No. 202410838667.2, filed on Jun. 26, 2024, the entire contents of which are incorporated herein by reference.

### TECHNICAL FIELD

The present application relates to the technical field of mosquito eradication devices, and in particular, to a gas-generating assembly and a mosquito eradication device.

### BACKGROUND

Carbon dioxide is often used as bait for mosquito trapping equipment. Dry ice is often used as a source of carbon dioxide, but due to its high cost and the difficulty in obtaining it in some remote areas, it cannot be used as a popular bait.

Another way is to use water, hydrochloric acid and limestone to react with reactants to produce a large amount of carbon dioxide, which can have a similar effect. However, since the bait needs to continuously release carbon dioxide to ensure the long-term effectiveness of the mosquito eradication device, it is necessary to continuously add water sources manually, which is very inconvenient.

### SUMMARY

The main purpose of the present application is to provide a gas-generating assembly and a mosquito eradication device, which aims to supply water for mosquito eradication device sustainably.

In order to achieve the above purpose, the present application provides a gas-generating assembly including a water-collecting structure, a reaction structure and a wind structure.

A bottom of the water-collecting structure being formed with an opening, and a surface of the water-collecting being provided with a hydrophilic layer to absorb water vapors in the air.

The reaction structure is provided under the water-collecting structure, the reaction structure is formed with an accommodation room to place a reactant, and the opening is correspondingly provided above the accommodation room; and

The wind structure is provided under the water-collecting structure and configured to generate a wind vortex to facilitate airs around the water-collecting structure contacting the hydrophilic layer.

In some embodiments, the water-collecting structure is provided in a funnel shape, and the hydrophilic layer is provided on an inner surface and an outer surface of the water-collecting structure.

In some embodiments, a plurality of guide grooves are formed on a side wall of the water collecting structure, and a width of each guide groove is configured to gradually decrease along a direction approaching the opening.

In some embodiments, “h” represents a height of the water-collecting structure, and 20 mm≤h≤40 mm; “d” represents a diameter of a top of the water-collecting structure, and 30 mm≤d≤60 mm; and “a” represents a slope of the water-collecting structure, and 20°≤a≤40°.

In some embodiments, a material of the water-collecting structure includes one or more of nano zinc oxide, nano iron oxide, nano aluminum oxide, calcium chloride, magnesium sulfate, lithium bromide, water-absorbing resin silica gel, porous ceramics, porous carbon, polyvinyl alcohol and fiber materials.

In some embodiments, the water-collecting structure includes a replaceable consumable, and the consumable includes one or more of calcium chloride, magnesium sulfate, lithium bromide, and water-absorbing resin silica gel.

In some embodiments, the reaction structure includes a reaction member, a support portion and an installation portion; one end of the support portion is connected to the reaction member, and the other end of the support portion is connected to the installation portion; and the installation portion is sleeved on an outer peripheral wall of the water-collecting structure, and the reaction member is configured to form the accommodation room.

This carbon dioxide gas-generating assembly can be combined with wind suction mosquito killer, sticky mosquito killer, electric shock mosquito killer and other application scenarios, or it can be used simultaneously in combination with several combined mosquito killing methods.

Calcium chloride particles can also be directly mixed with carbon dioxide tablets (the adsorbed water can directly react with the carbon dioxide tablets without the need for dripping) to make consumables. When the consumables are unpacked, calcium chloride comes into contact with the air, absorbs and converts water, and reacts chemically with the carbon dioxide tablets to produce carbon dioxide, which has the effect of attracting mosquitoes.

The present application further provides a mosquito eradication device including the above-mentioned gas-generating assembly; and a lamp body. A top of the lamp body is provided with an installation groove, and a periphery of the reaction structure is provided with a snap portion engaged with the installation groove.

In some embodiments, the lamp body includes an outer shell, a fan and a storage bin; an installation cavity is formed inside the outer shell, and the fan is provided in the installation cavity and is located under the reaction structure; the outer shell above the fan is hollowed out; and the storage bin is located under the fan and is communicated with the installation cavity, and an outer wall of the storage bin is provided with a mesh structure.

In some embodiments, the mosquito eradication device further includes an ultraviolet lamp provided in the outer shell and connected to a top wall of the lamp body, and the ultraviolet lamp being located between the water-collecting structure and the fan.

In some embodiments, the gas-generating assembly and the lamp body are separated or integrated.

In some embodiments, the mosquito eradication device further includes a water-supplying device configured to hold water for directly reacting with the reactant.

The technical solution of the present application collects water vapor in the air by using a hydrophilic layer of a water collection structure, so that the water vapor condenses into water droplets, which drip into the reaction structure below through the opening at the bottom under the action of their own gravity, and the water droplets react with the reactants to generate carbon dioxide gas to attract mosquitoes. By using a water collection structure to continuously collect water vapor in the air, and using a wind structure to improve the adsorption effect of the water collection structure, the speed of water production is adjusted by controlling the size of the wind force, thereby adjusting the speed of generating carbon dioxide gas, avoiding manually adding water to the mosquito killing device continuously, and improving the sustainability and convenience of mosquito killing.

### BRIEF DESCRIPTION OF THE DRAWINGS

In order to more clearly illustrate the technical solutions in the embodiments of the present application or in the related art, a brief introduction will be given to the accompanying drawings required in the description of the embodiments or the related art. Obviously, the accompanying drawings in the following description are only some embodiments of the present application. For those skilled in the art, other accompanying drawings can be obtained based on the structures shown in these drawings without any creative effort.

FIG. 1 is a schematic structural view of a gas-generating assembly according to some embodiments of the present application.

FIG. 2 is a schematic structural view of a mosquito eradication device according to some embodiments of the present application.

FIG. 3 is a schematic cross-sectional view of the mosquito eradication device in FIG. 2.

FIG. 4 is a schematic structural view of the mosquito eradication device according to some other embodiments of the present application.

The realization of the purpose, functional characteristics and advantages of the present application will be further described with reference to the accompanying drawings in combination with embodiments.

### DETAILED DESCRIPTION OF THE EMBODIMENTS

The technical solutions of the embodiments of the present application will be clearly and completely described below in conjunction with the accompanying drawings of the embodiments of the present application. It is obvious that the embodiments to be described are only some rather than all the embodiments of the present application. All other embodiments obtained by those skilled in the art based on the embodiments of the present application without creative efforts should fall within the scope of the present application.

It should be noted that all the directional indications (such as up, down, left, right, front, rear, etc.) in the embodiments of the present application are only used to explain the relative positional relationship, movement, or the like of the components in a certain posture (as shown in the drawings). If the specific posture changes, the directional indication will change accordingly.

In addition, the descriptions related to “first”, “second” and the like in the present application are merely for descriptive purposes, and should not be understood as indicating or implying their relative importance or implicitly indicating the number of technical features indicated. Therefore, the features defined by “first” and “second” may explicitly or implicitly include at least one such feature. In addition, “and/or” in the whole text includes three solutions, taking “A and/or B” as an example, including A technical solution, or B technical solution, or a technical solution that both A and B meet. Besides, the technical solutions among various embodiments can be combined with each other, but the combination must be based on what can be achieved by those skilled in the art. When the combination of technical solutions is contradictory or cannot be achieved, it should be considered that such combination does not exist, and is not within the scope of the present application.

Carbon dioxide is often used as bait for mosquito trapping equipment. Dry ice is often used as a source of carbon dioxide, but due to its high cost and the difficulty in obtaining it in some remote areas, it cannot be used as a popular bait.

Another way to produce a large amount of carbon dioxide can be achieved by chemically reacting with water, hydrochloric acid and limestone, which can achieve a similar effect. However, since the bait needs to continuously release carbon dioxide to ensure the long-term effectiveness of the mosquito eradication device, it requires continuous artificial addition of water, which is very inconvenient.

In order to solve the above problems, the present application provides a gas-generating assembly 100, including a water-collecting structure 1 and a reaction structure 2. The bottom of the water-collecting structure 1 is formed with an opening, and the surface of the water-collecting structure 1 is provided with a hydrophilic layer to absorb water vapor in the air. The reaction structure 2 is provided under the water-collecting structure 1. The reaction structure 2 is formed with an accommodation room for placing reactants, and the opening is correspondingly provided above the accommodation room.

The technical solution of the present application collects water vapor in the air by using the hydrophilic layer of the water-collecting structure 1, so that the water vapor condenses into water droplets, which drip into the reaction structure 2 below through the opening at the bottom under the action of their own gravity. The water droplets react with the reactants to generate carbon dioxide to attract mosquitoes. The water vapor in the air is continuously collected by using the water-collecting structure 1, and the adsorption effect of the water-collecting structure 1 is improved by using the wind structure. The speed of water production is adjusted by controlling the size of the wind force, thereby adjusting the speed of generating carbon dioxide, thereby avoiding continuously adding water to the mosquito eradication device 1000 manually, and improving the sustainability and convenience of mosquito eradication. The wind structure can be a tool such as a fan that can disturb the surrounding airflow, and the speed of the carbon dioxide production can be controlled by adjusting the speed of the fan.

In an embodiment, in order to ensure the water collection effect of the water-collecting structure 1, the water-collecting structure 1 is provided in a funnel shape, and the hydrophilic layer is provided on the inner surface and the outer surface of the water-collecting structure 1. In the actual design process, the shape of the water-collecting structure 1 can be selected in many ways. For example, the shape of the water-collecting structure 1 can be a columnar structure or a conical structure. The surface of the water-collecting structure 1 has a large enough area to absorb water vapor in the air, and water vapors can condense and flow into the reaction structure 2 below along the surface of the water-collecting structure 1 under the action of their own gravity. In this way, the water reacts with the reactants to generate carbon dioxide gas to attract mosquitoes. In this embodiment, in order to adsorb and collect water vapor, the water-collecting structure 1 is provided in a funnel shape. The funnel-shaped structure can have a large enough surface area to adsorb water vapor. The inner and outer surfaces of the funnel-shaped water-collecting structure 1 can adsorb water vapor in the air, and the water-collecting structure 1 is surrounded by a conical cavity to carry and collect water vapor. The inclined surfaces of the inner and outer walls can also facilitate the gradual condensation of water vapor into water droplets and flow down from the opening at the bottom, thereby ensuring the water collection effect of the water-collecting structure 1.

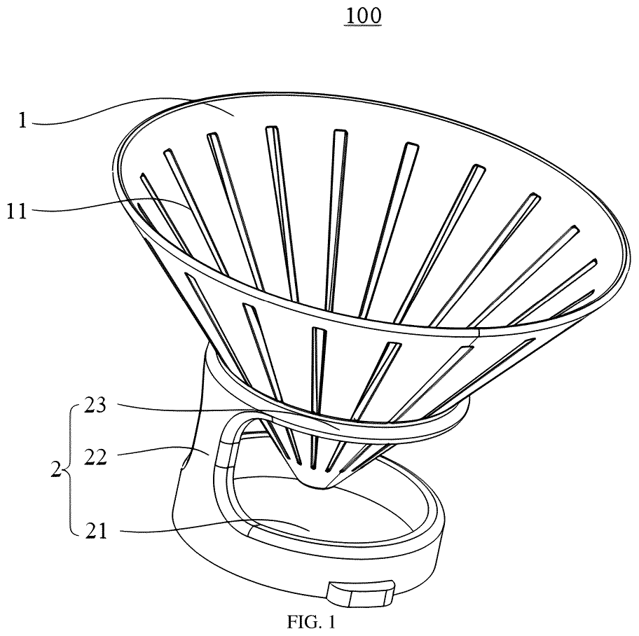

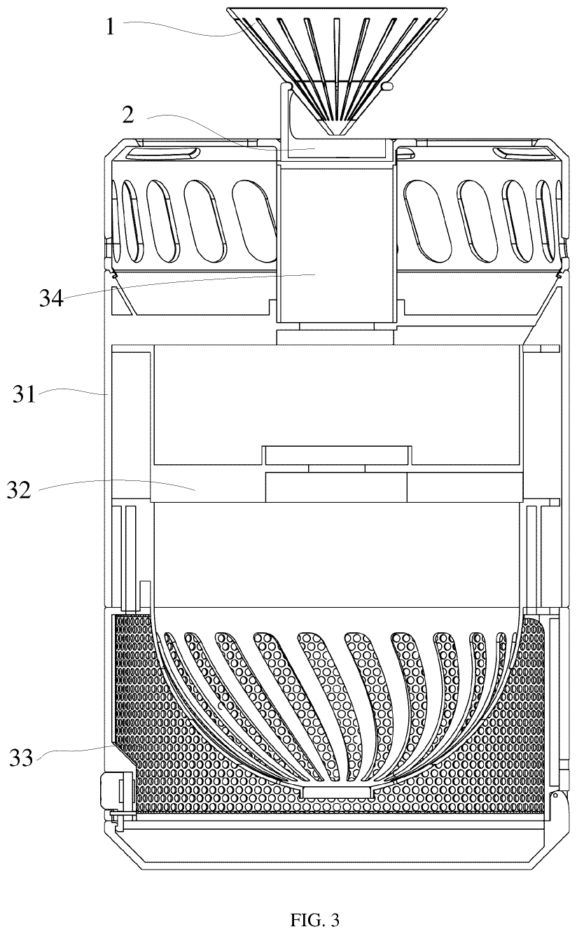

Further, in order to facilitate the contact and circulation between the water-collecting structure 1 and the outside air, the side wall of the water-collecting structure 1 is formed with a plurality of guide grooves 11, and the width of each guide groove 11 gradually decreases along the direction close to the opening. As shown in FIG. 1 and FIG. 3, by providing a plurality of guide grooves 11 on the side wall of the water-collecting structure 1, air on both sides of the water-collecting structure 1 may circulate, so as to better adsorb water vapor in the air on the side wall of the water-collecting structure 1. At the same time, it is also possible to ensure the stability of the water-collecting structure 1 after installation, so that the water-collecting structure 1 will not be easily blown or overturned when subjected to strong external wind force. Furthermore, in order to ensure that the water-collecting structure 1 has enough area to adsorb water vapor in the air after the guide groove 11 is provided, the size of the guide groove 11 is gradually reduced from top to bottom. In this technical solution, the shape of the guide groove 11 is a straight groove. In other embodiments, the guide groove 11 can be an arc groove or a groove structure of other shapes. No specific limitation is made here, and it can be selected according to actual needs.

In an embodiment, to ensure the water collecting effect of the water-collecting structure 1, “h” represents a height of the water-collecting structure, and 20 mm≤h≤40 mm; “d” represents a diameter of a top of the water-collecting structure, and 30 mm≤d≤60 mm; and “a” represents a slope of the water-collecting structure, and 20°≤a≤40°. In order to take into account both the water collection effect of the water-collecting structure 1 and the size of the water-collecting structure 1, in this embodiment, the size of the aperture of the top of the funnel-shaped water-collecting structure 1 may be from 30 mm to 60 mm, the height may be from 20 mm to 40 mm, the aperture of the opening at the bottom of the funnel may be from 3 mm to 5 mm, and the slope of the inner wall of the water-collecting structure 1 may be from 20° to 40°, so that water droplets can smoothly flow down from the opening through the slope. The above dimensions are a reference for ensuring that the water-collecting structure 1 can smoothly collect water vapor in the air and drip smoothly in this solution. In some embodiments, the speed of water droplets falling can be adjusted by controlling the size of the opening at the bottom of the water-collecting structure 1, thereby adjusting the speed of carbon dioxide generation to ensure that the carbon dioxide concentration is within the safe range that the human body can withstand. The carbon dioxide concentration can also be adjusted by adjusting the amount of reactants in the reaction structure 2. The specific size can be selected according to actual needs and the use environment of the water-collecting structure 1. In addition, in order to ensure that the effect of generating carbon dioxide can be achieved when the external environment is relatively dry, in addition to accelerating the water collection effect of the water-collecting structure 1 by using a wind structure, a water storage structure or a water supply structure can also be provided above the water-collecting structure 1 to ensure that water can drop into the accommodation room of the reaction structure 2 in a relatively dry environment to react with the reactant, thereby ensuring the effect of attracting mosquitoes.

In an embodiment, in order to improve the effect of the water-collecting structure 1 in absorbing water vapor, the material of the water-collecting structure 1 includes one or more of nano zinc oxide, nano iron oxide, nano aluminum oxide, calcium chloride, magnesium sulfate, lithium bromide, water-absorbing resin silica gel, porous ceramics, porous carbon, polyvinyl alcohol and fiber materials. When the material reaches the nanometer level, its specific surface area increases significantly, and the proportion of surface atoms increases sharply. These surface atoms have unsaturated valence bonds and can interact strongly with water molecules in the environment. Therefore, the surrounding water molecules are effectively adsorbed through the large number of active sites on the surface of nano zinc oxide, nano iron oxide, and nano aluminum oxide. When adsorbed to a certain extent, the adsorbed water forms liquid water droplets that drip from the opening. Since the chemical properties of nano materials are relatively stable and not easily affected by the environment, they can maintain their adsorption performance for a long time without the need to frequently replace the water-collecting structure 1. The main component of silica gel is silicon dioxide, which has many microporous structures. These micropores can adsorb water molecules to absorb water vapor in the air. In addition, silica gel has good stability and can maintain its own structure relatively stable during the water absorption process, thereby extending its service life. Porous ceramic materials and porous carbon materials have a large number of tiny pores inside, which can adsorb a certain amount of water to adsorb water vapor. The molecular structure of polyvinyl alcohol contains a large number of hydroxyl groups, which can form hydrogen bonds with water molecules, so that polyvinyl alcohol can absorb a large amount of water vapor. When fiber materials are used as the material of the water-collecting structure 1, natural fibers such as cotton fibers and cellulose can be selected, and synthetic fibers such as carboxymethyl cellulose and cellulose nanofibers can also be selected. The molecular structure of these fiber materials has hydrophilic groups that can be used to absorb water vapor in the air. The above-mentioned materials can be used as the matrix structure of the water-collecting structure 1, and can also be used as coatings to be coated on the inner and outer surfaces of the water-collecting structure 1. The specific selection can be based on actual needs.

Calcium chloride, MgSO4 (magnesium sulfate), LiBr (lithium bromide), water-absorbing resin silica gel can also be used as a consumable wrapped in a ventilated and breathable packaging bag and placed on a funnel or water absorption device, it will automatically absorb moisture from the air. When it is collected to a certain extent, the moisture will drip into the reaction structure due to gravity and react chemically to produce carbon dioxide. When the consumable is fully reacted, it can be directly replaced with a new consumable, which is convenient and quick.

In an embodiment, in order to facilitate the installation of the water-collecting structure 1 above the reaction structure 2, the reaction structure 2 includes a reaction member 21, a support portion 22 and an installation portion 23. Two ends of the support portion 22 are respectively connected to the reaction member 21 and the installation portion 23, the installation portion 23 is sleeved on the outer peripheral wall of the water-collecting structure 1, and the reaction member 21 forms the accommodation room. As shown in FIG. 3, the installation portion 23 is connected to the reaction member 21 through the support portion 22 at the bottom. In this embodiment, only one support portion 22 is provided on the installation portion 23 to support the water-collecting structure 1. In other embodiments, the number of the support portions 22 can be two or more, and the support portion 22 can be arranged at the periphery of the installation portion 23 and the reaction member 21. It is not specifically limited here and can be selected according to actual needs. By providing the installation portion 23 sleeved on the outer peripheral wall of the water-collecting structure 1 to stably support the water-collecting structure 1, the stability of the water-collecting structure 1 after installation is guaranteed, and the installation and replacement of the water-collecting structure 1 is greatly facilitated. In addition, by integrating the reaction member 21 and the support portion 22, the reaction structure 2 can be formed in one step. In some embodiment, in the present embodiment, the installation portion 23 is an annular structure, and the water-collecting structure 1 is inserted into the annular structure to achieve installation. In other embodiments, the installation portion 23 can be a plurality of supporting structures provided above the reaction member 21, and at least three supporting points are formed by the supporting structures to support and fix the water-collecting structure 1. In some embodiments, the installation portion 23 is provided at the outer edge of the water-collecting structure 1. In addition, in the present embodiment, the water-collecting structure 1 and the reaction structure 2 are split. In other embodiments, the water-collecting structure 1 and the reaction structure 2 can be designed as an integrated structure. It can be selected according to actual needs. In some embodiments, the reaction structure 2 can be made of plastic or metal, which can be selected according to actual needs. The reaction member 21 is provided with an accommodation room for placing reactants to react with the water droplets collected by the water-collecting structure 1. In this embodiment, a carbon dioxide effervescent tablet is used as the reactant. The main components of the carbon dioxide effervescent tablet are sodium bicarbonate and citric acid. After the carbon dioxide effervescent tablet contacts water molecules, a chemical reaction begins to occur, generating a large amount of carbon dioxide gas to attract mosquitoes.

The present application also provides a mosquito eradication device 1000, which includes a lamp body 3 and a gas-generating assembly 100. The specific structure of the gas-generating assembly 100 is referred to the above embodiment. Since the mosquito eradication device 1000 adopts all the technical solutions of all the above embodiments, it at least has all the beneficial effects brought by the technical solutions of the above embodiments, which will not be described one by one here. The top of the lamp body 3 is formed with an installation groove, and the outer edge of the reaction structure 2 is provided with a snap portion, and the snap portion is snapped in the installation groove. As shown in FIG. 1 and FIG. 3, two protruding structures are provided on the periphery of the reaction structure 2. The protruding structures are clamped in the installation groove and rotated relative to the installation groove to fix the reaction structure 2, so as to improve the stability of the installation of the reaction structure 2.

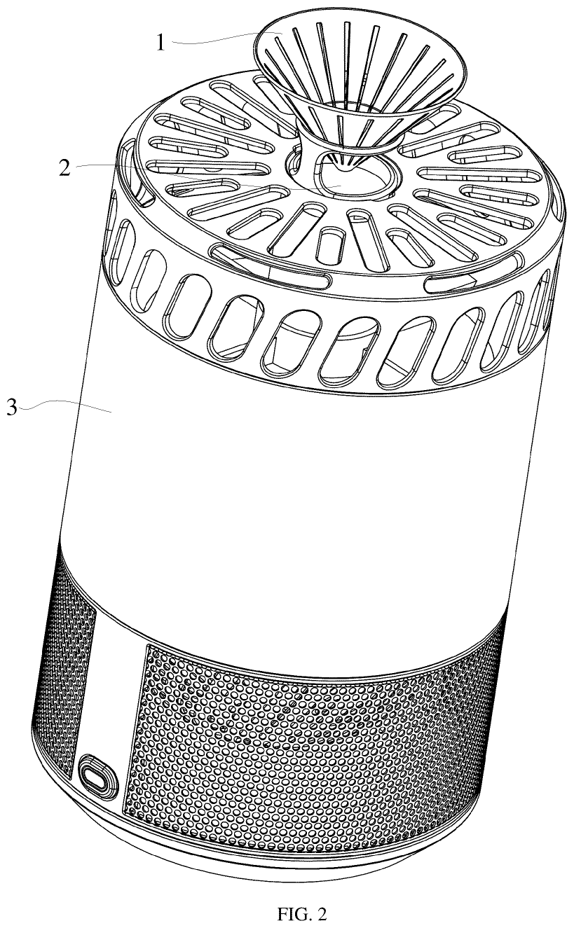

In an embodiment, in order to facilitate the mosquito eradication effect of the mosquito eradication device 1000, the lamp body 3 includes an outer shell 31, a fan 32 and a storage bin 33. The outer shell 31 is formed with an installation cavity. The fan 32 is provided in the installation cavity and is located below the reaction structure 2. The outer shell 31 above the fan 32 is hollowed out. The storage bin 33 is located below the fan 32 and communicates with the installation cavity. The outer wall of the storage bin 33 is provided with a mesh structure. As shown in FIG. 1 and FIG. 2, a plurality of holes are provided on the periphery of the top of the lamp body 3 so that mosquitoes can enter the outer shell 31 through the holes. A fan 32 in the installation cavity is provided. On the one hand, the fan 32 can disturb the air around the water-collecting structure 1 to speed up the water vapor collection speed of the water-collecting structure 1, and on the other hand, the fan 32 rotates to generate a wind vortex to roll the mosquitoes entering the lamp body 3 into the storage bin 33 below for collection. In some embodiments, a mosquito sticking plate can be provided at the bottom of the storage bin 33 to stick the mosquitoes, thereby achieving complete killing of the mosquitoes. In addition, a mesh structure is provided on the outer wall of the storage bin 33. On the one hand, the mesh structure can block the mosquitoes in the storage bin 33 to prevent the mosquitoes from escaping from the storage bin 33, and on the other hand, the mesh structure facilitates the air exchange between the storage bin 33 and the outside world, thereby ensuring the air permeability of the mosquito eradication device 1000.

In an embodiment, in order to further improve the effect of attracting mosquitoes, the mosquito eradication device 1000 further includes an ultraviolet lamp 34, which is provided in the outer shell 31 and connected to the top wall of the lamp body 3, and is located between the water-collecting structure 1 and the fan 32. As shown in FIG. 1 and FIG. 2, the ultraviolet lamp 34 is provided in the lamp body 3, and the ultraviolet lamp 34 is powered on to emit UV combination light to increase the attraction of mosquitoes, thereby improving the mosquito eradication effect. In some embodiments, the wavelength of the UV combination light includes 365 nm, 395 nm and 450 nm.

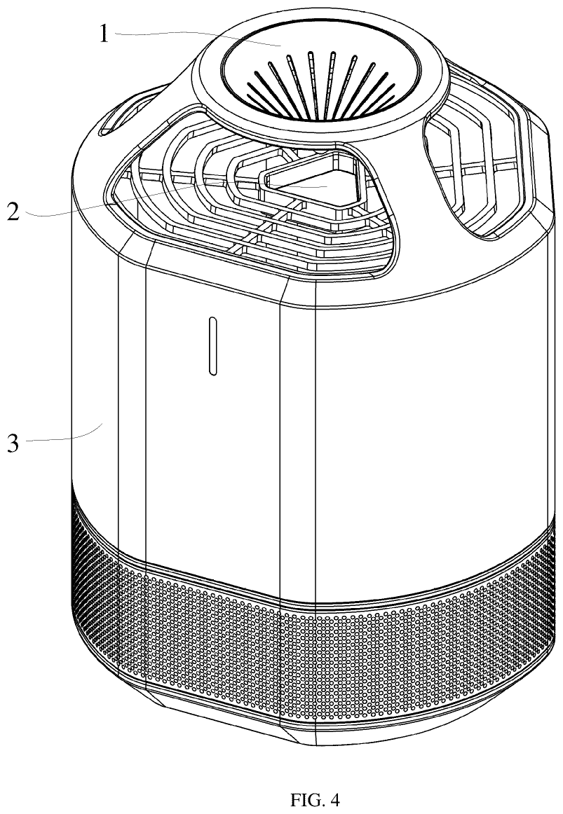

In an embodiment, the gas-generating assembly 100 and the lamp body 3 can be separated or integrated. FIG. 1 to FIG. 3 show embodiments of the separated mosquito eradication device 1000 in this solution. The gas-generating assembly 100 is clamped on the top of the lamp body 3 to achieve a detachable connection. In another embodiments, as shown in FIG. 4, the gas-generating assembly 100 and the lamp body 3 are integrated. The outer edge of the top of the lamp body 3 is provided with a connecting arm connected to the outer edge of the water-collecting structure 1. The top of the lamp body 3 corresponds to the bottom of the water-collecting structure 1 to form an accommodation room for placing reactants which may react to generate carbon dioxide gas to attract mosquitoes. The specific structure can be selected according to actual needs.

In some embodiments, the mosquito eradication device further includes a water-supplying device configured to hold water for directly reacting with the reactant. When the mosquito eradication device is in a dry environment, a water-supplying device can be placed directly on the mosquito eradication device to control the flow rate of water so that the water may react with the reactants to produce carbon dioxide.

The above are only some embodiments of the present application, and are not intended to limit the scope of the present application. Under the concept of the present application, equivalent structural transformations made according to the description and drawings of the present application, or direct/indirect application in other related technical fields, are included in the scope of the present application.

What is claimed is:

1. A gas-generating assembly, comprising:
a water-collecting structure, a bottom of the water-collecting structure being formed with an opening, and a surface of the water-collecting being provided with a hydrophilic layer to absorb water vapors in the air;
a reaction structure provided under the water-collecting structure, the reaction structure being formed with an accommodation room to place a reactant, and the opening being correspondingly provided above the accommodation room; and
a wind structure provided under the water-collecting structure and configured to generate a wind vortex to facilitate airs around the water-collecting structure contacting the hydrophilic layer.

2. The gas-generating assembly of claim 1, wherein the water-collecting structure is provided in a funnel shape, and the hydrophilic layer is provided on an inner surface and an outer surface of the water-collecting structure.

3. The gas-generating assembly of claim 2, wherein a plurality of guide grooves are formed on a side wall of the water collecting structure, and a width of each guide groove is configured to gradually decrease along a direction approaching the opening.

4. The gas-generating assembly of claim 3, wherein “h” represents a height of the water-collecting structure, and 20 mm≤h≤40 mm;
“d” represents a diameter of a top of the water-collecting structure, and 30 mm≤d≤60 mm; and
“a” represents a slope of the water-collecting structure, and 20°≤a≤40°.

5. The gas-generating assembly of claim 1, wherein a material of the water-collecting structure comprises one or more of nano zinc oxide, nano iron oxide, nano aluminum oxide, calcium chloride, magnesium sulfate, lithium bromide, water-absorbing resin silica gel, porous ceramics, porous carbon, polyvinyl alcohol and fiber materials.

6. The gas-generating assembly of claim 1, wherein the water-collecting structure comprises a replaceable consumable, and the consumable comprises one or more of calcium chloride, magnesium sulfate, lithium bromide, and water-absorbing resin silica gel.

7. The gas-generating assembly of claim 5, wherein the reaction structure comprises a reaction member, a support portion and an installation portion;
one end of the support portion is connected to the reaction member, and the other end of the support portion is connected to the installation portion; and
the installation portion is sleeved on an outer peripheral wall of the water-collecting structure, and the reaction member is configured to form the accommodation room.

8. A mosquito eradication device, comprising:
the gas-generating assembly of claim 1; and
a lamp body, a top of the lamp body being provided with an installation groove, and a periphery of the reaction structure being provided with a snap portion engaged with the installation groove.

9. The mosquito eradication device of claim 8, wherein the lamp body comprises an outer shell, a fan and a storage bin;
an installation cavity is formed inside the outer shell, and the fan is provided in the installation cavity and is located under the reaction structure;
the outer shell above the fan is hollowed out; and
the storage bin is located under the fan and is communicated with the installation cavity, and an outer wall of the storage bin is provided with a mesh structure.

10. The mosquito eradication device of claim 9, further comprising an ultraviolet lamp provided in the outer shell and connected to a top wall of the lamp body, and the ultraviolet lamp being located between the water-collecting structure and the fan.

11. The mosquito eradication device of claim 10, wherein the gas-generating assembly and the lamp body are separated or integrated.

12. The mosquito eradication device of claim 8, further comprising a water-supplying device configured to hold water for directly reacting with the reactant.
